(19) United States
(12) Patent Application Publication
(10) Pub. No.: US 2014/0308995 A1
(43) Pub. Date: Oct. 16, 2014

(54) PORTABLE WIRELESS CHARGING APPARATUS AND SYSTEM

(71) Applicant: Che-Min Wu, Torrance, CA (US)

(72) Inventor: Che-Min Wu, Torrance, CA (US)

(21) Appl. No.: 14/253,850

(22) Filed: Apr. 15, 2014

Related U.S. Application Data
(60) Provisional application No. 61/811,921, filed on Apr. 15, 2013.

(51) Int. Cl. H04B 1/38; H02J 7/00; H04W 52/02

(52) U.S. Cl. CPC H04B 1/3883; H04W 52/0296; H02J 7/007; H02J 2007/005
USPC 455/573

(57) ABSTRACT

A portable wireless charging apparatus may include a battery; a coil configured to detect whether a receiver of a first mobile device is nearby and to emit electrical magnetic pulses to realize the wireless charging; a wireless charging modulator configured to take direct current from the battery, transform the direct current into alternate current pulses and send the alternate current pulses to the coil; and a power control circuit to manage usage of the battery. In an exemplary embodiment, the power control circuit has a power managing unit and a detecting unit, said power managing unit configured to raise a battery level of the battery to a predetermined charging level, and said detecting unit continuously monitoring battery levels of the battery and a first battery in the first mobile device respectively to determine whether to terminate the wireless charging of the first mobile device.

### CROSS-REFERENCE TO RELATED APPLICATIONS

This application claims priority under 35 U.S.C. § 119 (e) to U.S. Provisional Patent Application Ser. No. 61/811,921, filed on Apr. 15, 2013, the entire contents of which are hereby incorporated by reference.

### FIELD OF THE INVENTION

The present invention generally relates to a wireless power charging system, and more particularly to a portable device or system to provide both regular cable charging and wireless charging to mobile electronic devices.

### BACKGROUND OF THE INVENTION

Mobile phones are used for a variety of purposes, including keeping in touch with family members, conducting business, and having access to a telephone in the event of an emergency. Some people carry more than one cell phone for different purposes, such as for business and personal use. More recently, smartphones emerged to quickly replace traditional mobile phones. Simply speaking, smartphones are mobile phones equipped with more advanced computing capability and connectivity to perform much more tasks than basic mobile phones. More particularly, smartphones typically combine the features of a mobile phone with some other popular consumer devices, such as a personal digital assistant (PDA), a media player, a digital camera, or a GPS navigation unit. Modern smartphones may include more features including a touchscreen computer, a web browser and a plurality of application software (“Apps”).

One of the most important concerns of smartphone users is the battery life. As stated above, modern smartphones can perform just like a mini computer, however, unlike computers that may be used with the power cords for most of the time, smartphone users usually carry the phones with them and the battery inside the phone may be a sole power source thereof. Therefore, it may be inconvenient for the users if the battery cannot last long enough and the smartphone may lose the portability if the user has to charge it often.

To solve the battery issues in smartphones and other mobile devices such as tablets, currently people take power banks with them to prevent the mobile devices from running out of battery. A USB cable is usually needed to charge the mobile device, so if the user forgets to bring the USB cable with him/her, the mobile device cannot be charged. Although some manufactures make power banks with USB cables irremovable therefrom, the aesthetics value of the power bank may be sacrificed, as well as the integrity and rigidness thereof.

There are also smartphones having internal components, so the phones can be charged wirelessly, literally without connecting to the charging dock through cables. However, all wireless power banks need to be plugged to the regular 110V power supply on the wall, and people still cannot wirelessly charge their mobile device(s) wherever and whenever they need to. The wireless power bank that still needs to be plugged to the power supply on the wall is not considered “portable” because people cannot use it on the go.

U.S. Pat. No. 8,432,129 to Lee et al. (hereinafter “Lee”) disclosing a wireless charging system can optimize charging efficiency regardless of a location of a mobile terminal. More specifically, the wireless charging system wirelessly charges a mobile terminal using electromagnetic induction between a first coil included in a charging pad and a second coil included in the mobile terminal. The charging pad can detect a location of the mobile terminal on the charging pad. The charging pad can move the first coil to correspond to the detected location of the mobile terminal; and supply power to the first coil and charging a battery. However, the power source of the wireless charging system, as shown in FIG. 1, is still from a power cord plugging to the wall, which may still be inconvenient for the user when the socket is not available. Therefore, there remains a need for a new and improved portable wireless power bank to overcome the problems stated above.

### SUMMARY OF THE INVENTION

It is an object of the present invention to provide a portable power bank to wirelessly charge mobile devices and the portable power bank does not need to connect to the power source on the wall while charging the mobile device.

It is another object of the present invention to provide a portable power bank to wirelessly and more efficiently charge the mobile devices than traditional wired chargers.

It is a further object of the present invention to provide a portable power bank that can simultaneously charge more than one mobile devices.

In one embodiment, a portable wireless charging apparatus to wirelessly charge a mobile device may include a wireless charging surface; a main case, a battery level indicator, a power control button and one or more USB ports. When in use, the user can simply dispose a mobile device, such as a cell phone with a receiver onto the wireless charging surface, the cell phone can be charged within a few seconds.

The portable wireless charging apparatus may include an upper cover, a coil, a wireless charging modulator and a battery, and a power control circuit. The upper cover is located underneath the wireless charging surface and is used to cover every component inside the main case. The coil is configured to emit electrical magnetic pulses to realize the wireless charging, and the wireless charging modulator is configured to take direct current from the battery, transform the direct current into alternate current pulses and send the alternate current pulses to the coil. In one embodiment, the battery is the central power source of the power bank, and the battery can be, but not limited to a regularly 3.7V Li-ion rechargeable battery. The battery powers the power control circuit that includes one or more USB ports for regular cable charging. The power control circuit may include a battery charging port for charging the battery from outer power sources.

In an exemplary embodiment, the power control circuit may include a power managing unit configured to manage the usage of the battery. More precisely, the power managing unit is configured to slightly raise the battery voltage from 3.7V to a predetermined level that is sufficient to charge the mobile devices. For example, to charge an iPhone, the battery voltage has to be raised to around 5V.

### BRIEF DESCRIPTION OF THE DRAWINGS

FIG. 1 is a prior art disclosing a wireless charging system can optimize charging efficiency regardless of a location of a mobile terminal.

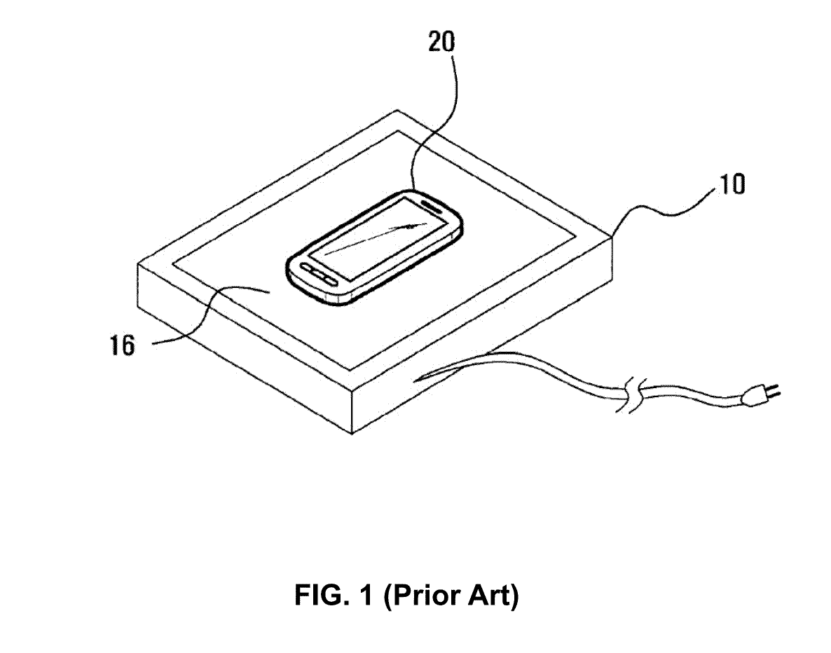

FIG. 2 illustrates a schematic view of the portable power bank in the present invention.

FIG. 3 illustrates an exploded view of the portable power bank in the present invention.

FIG. 4 illustrates a schematic view of the connection between the components of the portable power bank in the present invention.

FIG. 5 illustrates a schematic view of the portable power bank that is charging a mobile device in the present invention.

FIG. 6 illustrates a block diagram of wireless charging shown in FIG. 4.

FIG. 7 illustrates a schematic view of the portable power bank that is performing dual charging in the present invention.

### DETAILED DESCRIPTION OF THE INVENTION

The detailed description set forth below is intended as a description of the presently exemplary device provided in accordance with aspects of the present invention and is not intended to represent the only forms in which the present invention may be prepared or utilized. It is to be understood, rather, that the same or equivalent functions and components may be accomplished by different embodiments that are also intended to be encompassed within the spirit and scope of the invention.

Unless defined otherwise, all technical and scientific terms used herein have the same meaning as commonly understood to one of ordinary skill in the art to which this invention belongs. Although any methods, devices and materials similar or equivalent to those described can be used in the practice or testing of the invention, the exemplary methods, devices and materials are now described.

All publications mentioned are incorporated by reference for the purpose of describing and disclosing, for example, the designs and methodologies that are described in the publications that might be used in connection with the presently described invention. The publications listed or discussed above, below and throughout the text are provided solely for their disclosure prior to the filing date of the present application. Nothing herein is to be construed as an admission that the inventors are not entitled to antedate such disclosure by virtue of prior invention.

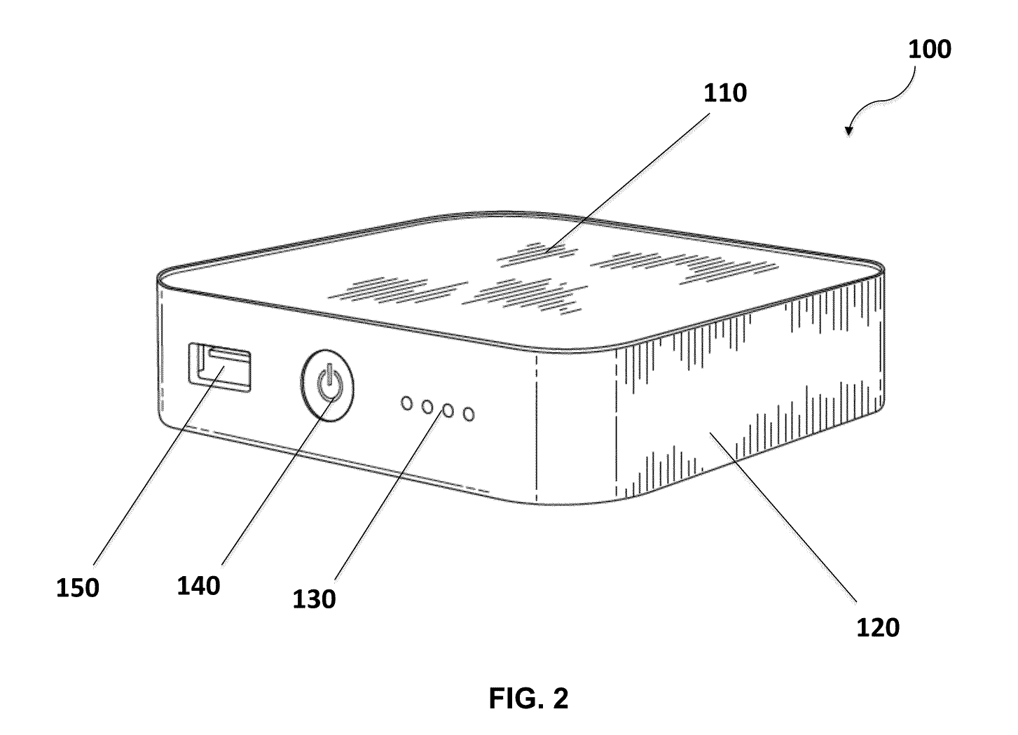

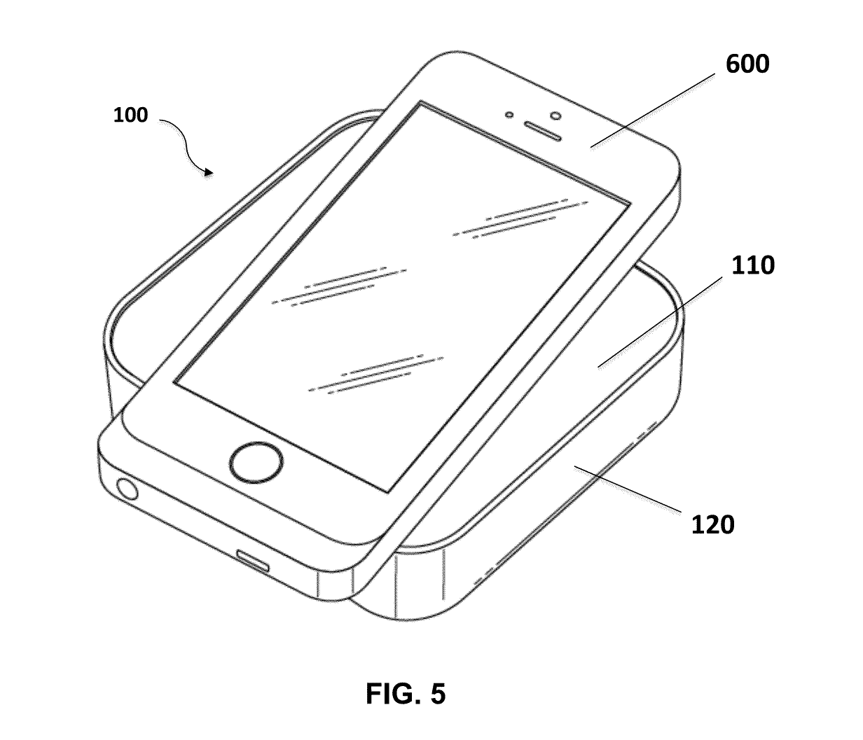

Typical wireless charging system applies power to a charging apparatus including a coil therein, and charges a battery using an induced current generating in a receiver included in a mobile terminal, or a battery using a magnetic field generating in the coil in the charging apparatus. Referring to FIGS. 2, 5 and 6, a portable power bank 100 that is used to wirelessly charge a mobile device may include a wireless charging surface 110; a main case 120, a battery level indicator 130, a power control button 140 and one or more USB ports. When in use, the user can simply dispose a mobile device, such as a cell phone 600 with a receiver 610 onto the wireless charging surface 110, the cell phone 600 can be charged within a few seconds. It is noted that the portable power bank 100 is not connected or plugged into any power supply on the wall when charging the cell phone 600.

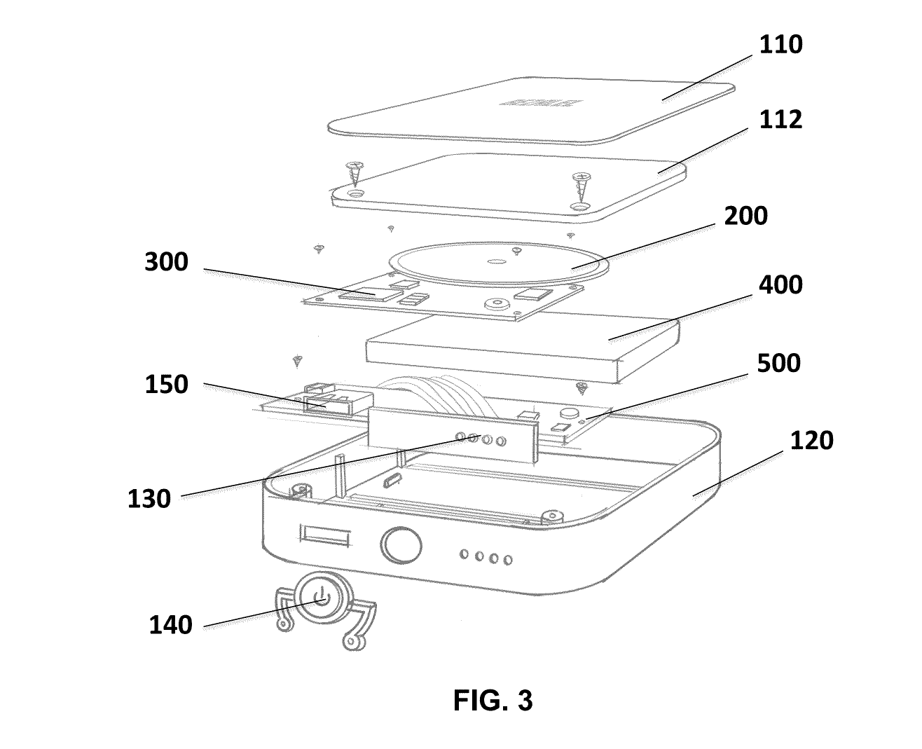

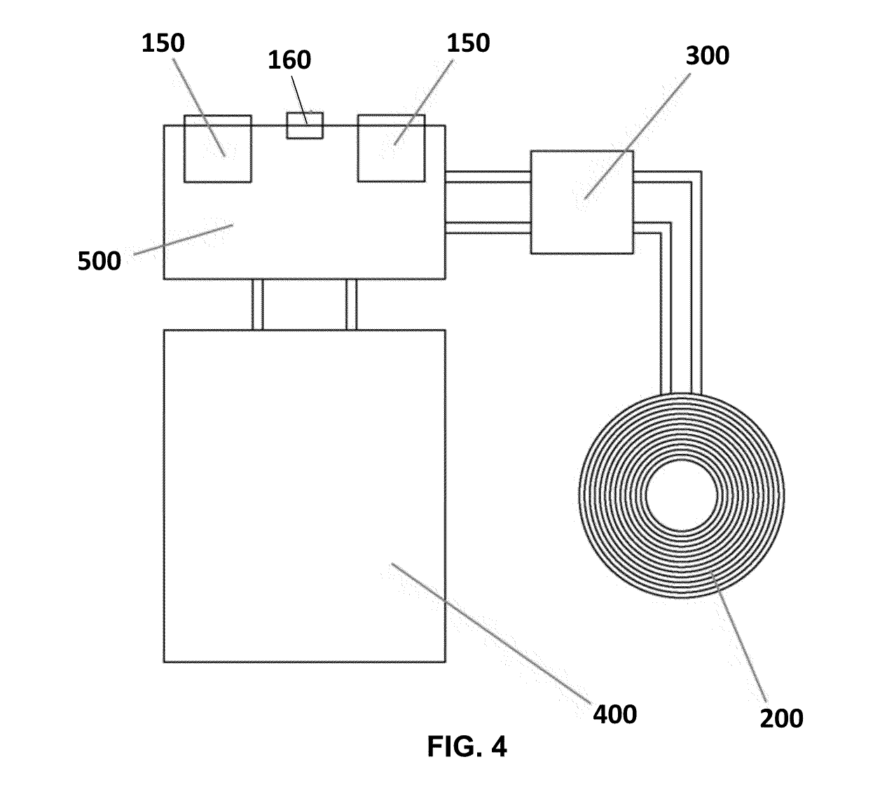

Referring to FIGS. 3 and 4, the portable power bank 100 may include an upper cover 112, a coil 200, a wireless charging modulator 300 and a battery 400, and a power control circuit 500. The upper cover 112 is located underneath the wireless charging surface 110 and is used to cover every component inside the main case 120. The coil 200 is configured to emit electromagnetic pulses to realize the wireless charging, while the wireless charging modulator 300 is configured to take direct current from the battery 400, transform the direct current into alternate current pulses and send the alternate current pulses to the coil 200. The battery 400 can be the central power source of the portable power bank 100 in the present invention, and in one embodiment, the battery 400 can be, but not limited to a regularly 3.7V Li-ion rechargeable battery. Also, the battery 400 powers the power control circuit 500 that includes one or more USB ports 150 for regular cable charging. The power control circuit 500 may include a battery charging port 160 for charging the battery 400 from external power sources. In one embodiment, the battery charging port 160 can be a micro USB port.

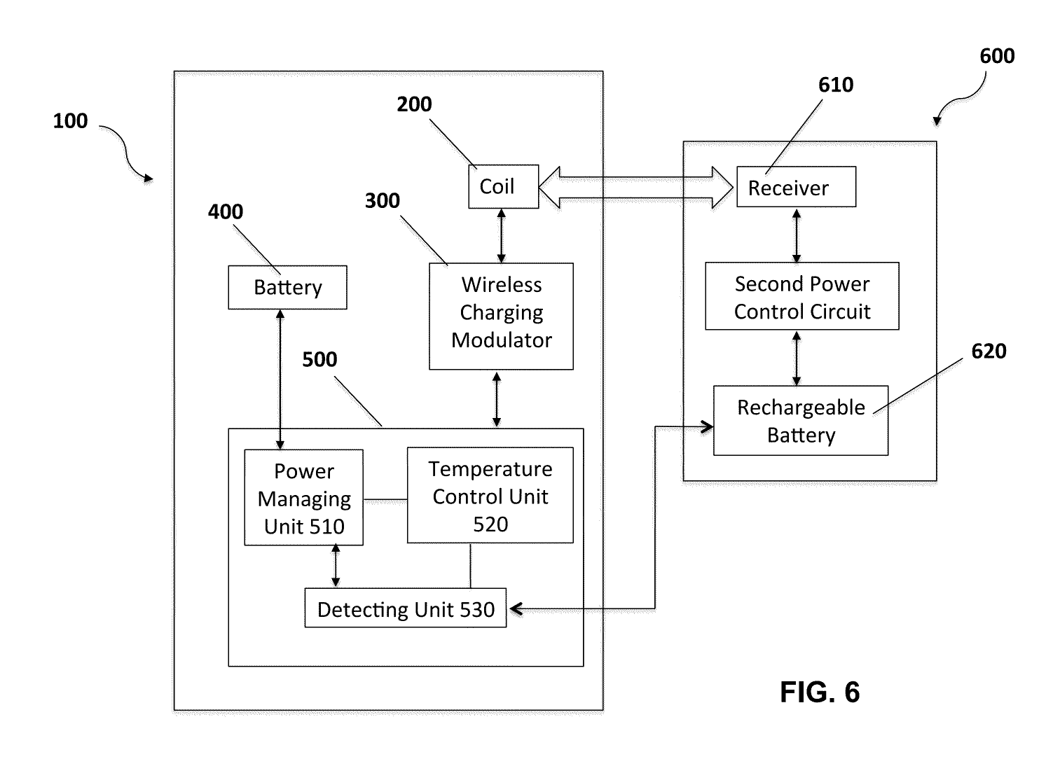

As stated above, the battery life is one of the most important concerns among the smartphone users, so is for the portable power bank 100. In an exemplary embodiment as shown in FIG. 6, the power control circuit 500 may include a power managing unit 510 that is configured to managing the usage of the battery 400. More particularly, the power managing unit 510 is configured to detect a minimum charging voltage of a mobile device and then raise the battery voltage from 3.7V to the charging voltage so the mobile device can be charged under the charging voltage. For example, when the portable power bank 100 is used to charge an iPhone whose minimum charging voltage is 5V, the power managing unit 510 would raise the battery voltage from 3.7V to 5V.

Comparing to conventional wireless chargers that have to be connected to the power socket on the wall, the portable power bank 100 can be carried with the user wherever the users want to go without worry about the availability of the power socket. Furthermore, the power bank 100 in the present invention has high efficiency in both charging (the mobile device) and battery usage because the power managing unit 510 simply raises the battery voltage to a charging voltage, e.g. from 3.7V to 5V; while conventional wireless chargers covert the power from a much higher voltage (e.g. 110V) to the charging voltage (e.g. 5V for iPhone).

Temperature is an important factor for battery life and efficiency. High temperature may adversely affect the battery life and efficiency. In a further embodiment as shown in FIG. 6, the power control circuit 500 may also include a temperature control unit 520 to control and reduce the heat emission while the power bank 100 is charging the mobile device to increase the battery life and efficiency. The power control circuit 500 may further include a detecting unit 530 configured to continuously monitor the charging status of a rechargeable battery 620 in the mobile device (600) being charged and the battery 400. When the detecting unit 300 concludes that the mobile device 600 has been fully charged, the wireless charging function would be terminated within a few seconds to save the battery power.

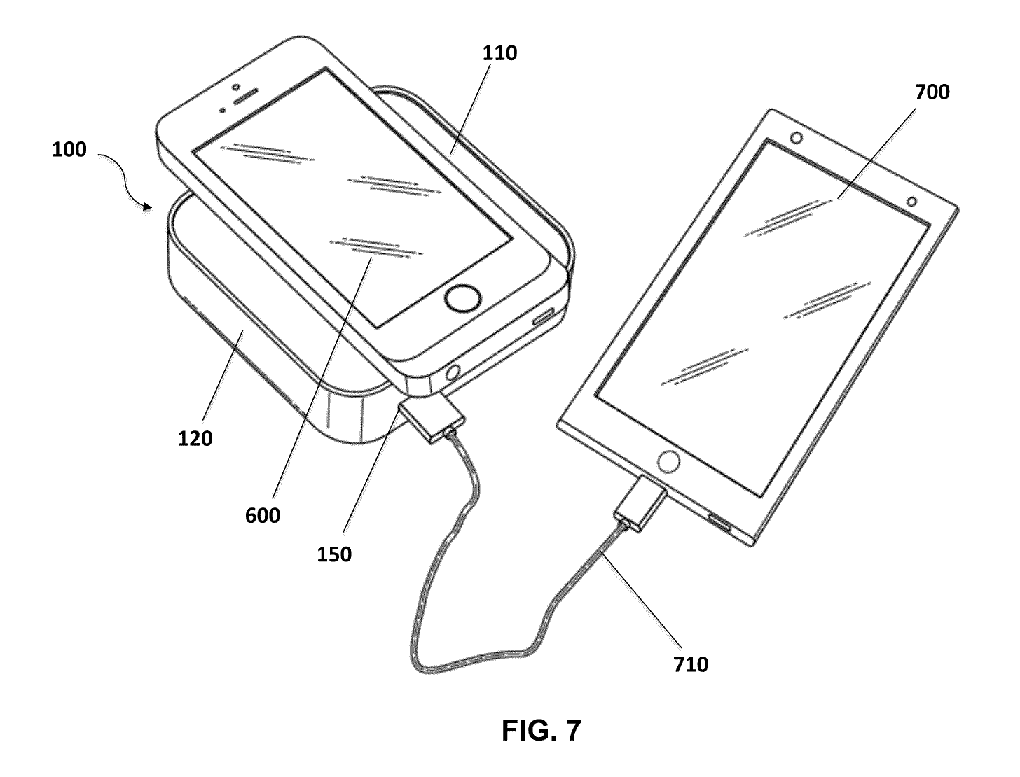

It is noted that since the battery is efficiently used, the portable power bank 100 in the present invention can be used to simultaneously charge more than one mobile devices. As shown in FIG. 7, one device 600 can be wirelessly charged on the wireless charging surface 110, while the other device 700 can be charged through a charging cable 710, which is designed for some mobile devices that can be wirelessly charged.

The wireless charging signal modulator 300 is connected in parallel to the power control circuit 500, taking the power from the battery 400 and transforming the direct current into alternative current pulses. The coil 200 is disposed inside the main case 120 to detect if there is a receiver 610 nearby, and paired to the wireless charging modulator 300 to emit electrical magnetic signals as receiving alternative current pulse therefrom. It is noted that for specific models of smartphones with receivers already installed, or any smartphones with charging backpack (include the receiving coils and regulator IC) attached, they can be charged when placed adjacent to the power bank 100.

Compared to regular power banks or other portable power resources, the portable power bank 100 in the present invention is easier to carry, since the USB cable is not always necessary. Furthermore, it is easier to manufacture since it possesses more integrity for its outer appearance. The possible implementation of this power bank 100 may separate the battery 400, power control circuit 500 and USB ports 150 away from the modulator 300 and coil 200; or put all of them together into one case. Both implementations are identical in terms of the charging capabilities.

Having described the invention by the description and illustrations above, it should be understood that these are exemplary of the invention and are not to be considered as limiting. Accordingly, the invention is not to be considered as limited by the foregoing description, but includes any equivalents.

What is claimed is:

1. A portable wireless charging apparatus comprising:
a battery;
a coil configured to detect whether a receiver of a first mobile device is nearby and to emit electrical magnetic pulses to realize the wireless charging;
a wireless charging modulator configured to take direct current from the battery, transform the direct current into alternate current pulses and send the alternate current pulses to the coil; and
a power control circuit to manage usage of the battery,
wherein the power control circuit has a power managing unit and a detecting unit, said power managing unit configured to raise a battery level of the battery to a predetermined charging level, and said detecting unit continuously monitoring battery levels of the battery and a first battery in the first mobile device respectively to determine whether to terminate the wireless charging of the first mobile device.

2. The portable wireless charging apparatus of claim 1, wherein the power control circuit further includes a temperature control unit to control and reduce the heat emission while the first mobile device is wirelessly charged.

3. The portable wireless charging apparatus of claim 1, wherein the power control circuit includes one or more USB ports for regular cable charging.

4. The portable wireless charging apparatus of claim 2, wherein the power control circuit includes one or more USB ports for regular cable charging.

5. The portable wireless charging apparatus of claim 3, wherein a second mobile device is charged through a cable plugged into one of the USB ports while the first mobile device is being wirelessly charged.

6. The portable wireless charging apparatus of claim 4, wherein a second mobile device is charged through a cable plugged into one of the USB ports while the first mobile device is being wirelessly charged.

7. The portable wireless charging apparatus of claim 1, further comprising a wireless charging surface, a main case, a battery level indicator, and a power control button, wherein the main case is used to receive the coil, the wireless charging modulator, the battery and the power control circuit therein.

8. A wireless charging system comprising:
a power bank including a battery; a coil to emit electrical magnetic pulses to realize the wireless charging; a wireless charging modulator configured to take direct current from the battery, transform the direct current into alternate current pulses and send the alternate current pulses to the coil; and a power control circuit to manage usage of the battery, wherein the power control circuit has a power managing unit and a detecting unit, said power managing unit configured to raise a battery level of the battery to a predetermined charging level, and
a first mobile device including a receiver and a first battery,
wherein the coil is configured to detect whether a receiver of a first mobile device is nearby, and the power control circuit has detecting unit to continuously monitor battery levels of the battery and the first battery in the first mobile device respectively to determine whether to terminate the wireless charging of the first mobile device.

9. The wireless charging system of claim 8, wherein the power control circuit further includes a temperature control unit to control and reduce the heat emission while the first mobile device is wirelessly charged.

10. The portable wireless charging apparatus of claim 8, wherein the power control circuit includes one or more USB ports for regular cable charging.

11. The portable wireless charging apparatus of claim 9, wherein the power control circuit includes one or more USB ports for regular cable charging.

12. The portable wireless charging apparatus of claim 10, wherein a second mobile device is charged through a cable plugged into one of the USB ports while the first mobile device is being wirelessly charged.

13. The portable wireless charging apparatus of claim 11, wherein a second mobile device is charged through a cable plugged into one of the USB ports while the first mobile device is being wirelessly charged.

14. The portable wireless charging system of claim 8, wherein the power bank further comprises a wireless charging surface, a main case, a battery level indicator, and a power control button, wherein the main case is used to receive the coil, the wireless charging modulator, the battery and the power control circuit therein.
